(19) United States
(12) Patent Application Publication
(10) Pub. No.: US 2006/0209939 A1
(43) Pub. Date: Sep. 21, 2006

(54) Adaptive coding for a shared data communication channel

(75) Inventor: Ramesh Mantha, Toronto (CA)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: Soma Networks, Inc., San Francisco, CA (US)

(21) Appl. No.: 10/568,357

(22) PCT Filed: Aug. 12, 2004
(86) PCT No.: PCT/CA04/01459

§ 371 Date: Feb. 14, 2006

(30) Foreign Application Priority Data
Aug. 14, 2003 (CA) 2437927

(51) Int. Cl. H04L 5/16; H04B 15/00

(52) U.S. Cl. 375/221; 375/285

(57) ABSTRACT

A method, system and apparatus for determining a block format to be used to transmit a block of data over a channel to a receiver by collecting a series of reception-quality measurements, determining the rate of change of the reception-quality or the rate at which retransmission requests are being made, and, depending upon the magnitude of the rate of change or the rate of retransmission requests, either: averaging the lowest portion of the reception-quality measurements during the time-series and determining the block format based upon the average; or determining the block format based upon the most recent reception-quality measurements.

### FIELD OF THE INVENTION

The present invention relates generally to a method and system for transmitting data through a shared communication channel. More specifically, the present invention relates to a method and system for transmitting data between stations, such as the radio base station and subscriber stations in a wireless local loop system, or the like, in which the receivers experience varying reception-qualities and the data transmissions to them are packaged correspondingly.

### BACKGROUND OF THE INVENTION

As used herein, the terms “package”, “packaged” and “packaging” refer to the overall arrangement for the transmission of packaged data for its reception at an intended destination receiver. Packaging of data can include, without limitation, applying different levels of forward error correcting (FEC) codes (from no coding to high levels of coding and/or different coding methods), employing various levels of symbol repetition, employing different modulation schemes (4-QAM, 16-QAM, 64-QAM, etc.) and any other techniques or methods for arranging data transmission with a selection of the amount of radio (or other physical layer) resources require the data rate and probability of transmission errors which are appropriate for the transmission. For example, data can be packaged with rate 1/4 FEC coding (each 1 data bit is transmitted in 4 bits of information) and 16-QAM modulation for transmission to a first intended receiver and packaged with rate 1/2 FEC coding and 64-QAM modulation for transmission to a second intended receiver which has a better reception quality than the first.

The ability of a subscriber station to properly receive a signal transmitted to it, referred to herein as the “reception-quality”, may change more or less rapidly with time, making it desirable to either (1) package data to be received by the subscriber station so as to provide a target level of reliability under most conditions or (2) adapt the packaging of data to be received by the subscriber station in response to changes in reception-quality at the subscriber station. The variation of receptor-quality with time is generally referred to as “channel fading”.

FIGS. 1A-1D shown four idealized examples of channel fading. In each, “SIR” (Signal-to-Interference Ratio), which is a measure of reception-quality experienced by the receiver, is plotted as a function of time over a short period of time (on the order of a half second in each case).

In FIG. 1A, an example is shown in which the channel over which data is transmitted is a line-of-sight, pure additive Gaussian white noise channel in which the reception-quality is constant.

In FIG. 1B, an example is shown in which the subscriber station or objects in the channel, such as people in the room in which the subscriber station is located, are moving at pedestrian velocity, resulting in a varying reception-quality. One way to handle such varying reception-quality has been to measure the reception-quality and adapt the packaging of data so that the data is packaged in a manner that takes account the measured reception-quality of the most recently received data.

The rate at which packaging can be adapted is typically limited by the delay between the measurement of reception-quality at a subscriber station and the transmission by the base station of a block whose packaging has been determined from the measurement.

A limited adaptation rate is not a serious problem when the reception-quality is increasing, but when the reception-quality is decreasing, packaging will be determined on the basis of too high a reception-quality measurement, thereby causing errors and decreasing the data rate to that subscriber station. To compensate for this, a “fade mar” is typically provided, so that the reception-quality used to determine packaging is lower by the fade margin than the last measurement of the reception-quality obtained from the subscriber station. A fade margin is typically selected on the basis of the expected maximum rate of change of the reception-quality. If the fade margin is not large enough, then the packaging used may frequently be based upon too high a reception quality, leading to an increase in the error rate, which in turn necessitates retransmission of data. The result may be a significant decrease in the data rate. In the past this decrease in the data rate has been accepted as the price to be paid for the higher data rate that may be obtained between fast fades.

FIG. 1C shows an example of a fasts deep fade in which the rate of change of the reception quality is extremely large surrounding the fade. Such fading may be caused by fast motion of objects in the channel, destructive interference between multiple paths, or other phenomena known to those skilled in the art. If adaptation were used, a prohibitively large fade margin would have to be set to avoid error correction. If such fades are expected, all data is typically packaging based upon a fixed reception-quality that is low enough to avoid error correction under most conditions.

FIG. 1D shows an example of a slow drifting fade. In this case, adaptation of the reception-quality as discussed in relation to FIG. 1B typically works, provided that it is rapid enough and an adequate fade margin is provided.

In some wireless communications systems, particularly those in which the subscriber stations are mobile, packaging is fixed and based upon a fade margin relative to the average SIR of the channel such that a target level of reliability is guaranteed. Of course, under many circumstances fixed packaging will provide a lower data transfer rate than adaptation, but in mobile wireless communication systems adaptation has been difficult to implement due to the need to deal with hand-off from one base station to another. In addition, the difficulties with adaptation in relation to the fading shown in FIG. 1C are more likely to occur in mobile wireless communications systems than in fixed wireless communications system due to the possibility of much faster movement of the subscriber stations.

It is evident from the above that present methods of packaging data need to be improved for channels that are subject to varying fading conditions.

### SUMMARY OF THE INVENTION

According to a fist aspect of the present invention, a method is provided for determining block formats to be used to transmit blocks of data from a base station to a subscriber station over a channel subject to fading is provided. The method includes monitoring a measure of the rate of change of a reception-quality of data received over the channel by the subscriber station from the base station, measuring the reception-quality of each frame of data received over the charnel by the subscriber station from the base station, and mapping each reception-quality measurement to a set of transmit-control bits using a quantization mapping. Each set of transmit-control bits is transmitted from the subscriber station to the base station in a slotted frame of data, each transmit-control bit carried in a discrete slot. The block format for the next block to be transmitted by the base station to the subscriber station is determined either by:

(a) using the most recently received set of transmit-control bits and the quantization mapping, or

(b) using an average of a portion of the reception-quality measurements for frames of data received over the channel by the subscriber station from the base station.

Step (a) is used when the measure of the rate of change indicates that measurements of reception-quality can be obtained and provided to the base station fast enough so that each measurement is a reasonably accurate estimate of the reception-quality at which the subscriber station will receive the next block to be transmitted. Otherwise (b) is used.

Preferably, the reception-quality measurements used to determine the average are sorted into portions by magnitude and one of the portions so determined is used to determine the average and the sorted portion used to determine the average is the portion having the lowest magnitudes.

According to a second aspect of the present invention, a method is provided for determining block formats to be used to transmit blocks of data from a base station to a subscriber station over a channel subject to fading. The method includes, at the subscriber station, measuring a reception-quality of a frame of data received over the channel by the subscriber station from the base station, and mapping the reception-quality measurement to a set of transmit-control bits using a quantization mapping. The set of transmit-control bits is then transmitted to the base station in a slotted flame of data, each transmit-control bit carried in a discrete slot. At the base station, using the set of transmit-control bits and the quantization mapping, a block format for the next block to be transmitted to the subscriber station is determined.

According to a third aspect of the present invention, a method is provided for determining block formats to be used to transmit from a transmitter to a receiver a series of blocks of data over a channel subject to fading. The method includes collecting a series of measurements of a reception-quality of blocks of data transmitted over the channel from the transmitter to the receiver and determining a measure of the rate of change of the reception-quality of blocks of data transmitted over the channel from the transmitter to the receiver. If the measure of the rate of change indicates that measurements of reception-quality cannot be obtained and provided to the transmitter fast enough so that each measurement is a reasonably accurate estimate of the reception-quality at which the receiver will receive a block of the series of blocks about to be transmitted, then an average of at least a portion of the series of reception-quality measurements is determined and, based upon that average, a block format to be used for each of the series of blocks to be transmitted is determined, but otherwise a block format for each block of the series of blocks to be transmitted based upon the most recent reception-quality measurement available to the transmitter at the time that that block is being prepared to be transmitted is determined.

According to a fourth aspect of the present invention, a method is provided for determining block formats to be used to trait blocks of data from a transmitter to a receiver over a channel subject to fading. The method included monitoring a measure of the rate of change of the reception quality for blocks of data transmitted over the channel from the transmitter to the receiver. The method alternates between determining a block format for the next block to be transmitted (a) using the most recent reception-quality measurement available to the transmitter at the time that next block is about to be transmitted, and (b) using measurements of reception-quality of a previous series of blocks of data transmitted over the channel from the transmitter to the receiver to determine an average of a portion of the reception-quality measurements and, based upon that average, determining a block format to be used for the blocks in the series of blocks to be transmitted. Step (a) is used when the measure of the rate of change indicates that measurements of reception-quality can be obtained and provided to the transmitter fast enough so that each measurement is a reasonably accurate estimate of the reception-quality at which the receiver will receive the next block to be transmitted and step (b) is used otherwise.

Preferably, the measure of the rate of change of the reception-quality of blocks of data transmitted over the channel from the transmitter to the receiver is determined periodically, but with a different period or phase than measurements of reception-quality of series of blocks of data transmitted over the channel from the transmitter to the receiver are collected. The measure of the rate of change of the reception-quality may be determined from a sequence of reception-quality measurements. Alternatively, the measure of the rate of change of the reception-quality may be determined by finding the frequency spectrum of a sequence of reception quality measurements or from the rate at which the receiver is requesting retransmissions over the channel from the transmitter.

According to a fifth aspect of the present invention, a method is provided for determining a block format to be used to transmit a series of blocks of data over a channel subject to fading from a transmitter to a receiver. The method includes collecting a series of measurements of a reception-quality of blocks of data transmitted over the channel from the transmitter to the receiver, determining an average of at least a portion of the series of reception-quality measurements, and determining the block format for each of the series of blocks to be transmitted based upon the average. Preferably, the reception-quality measurements to be used to determine an average are sorted into portions by magnitude and one of the portions so determined is used to determine the average and the sorted portion used to determine the average is the portion having the lowest magnitudes.

According to a sixth aspect of the present invention, a method is provided for determining a block format to be used to transmit a series of blocks of data over a channel subject to fading from a base station to a subscriber station. The method includes measuring a reception-quality for each frame of data received over the channel by the subscriber station from the base station and periodically determining an average of at least a portion of the reception-quality measurements. Either each reception-quality measurement is used to determine a block format for the next block to be transmitted to the subscriber station or, under predetermined conditions, the block format for the next block to be transmitted is determined based upon the last determined average.

Preferably, each reception-quality measurement is mapped to a set of transmit-control bits using a quantization mapping and the set of transmit-control bits transmitted to the base station in a slotted frame of data, each transmit-control bit carried in a discrete slot. The quantization mapping is used by the base station to determine a reception-quality measurement to be used to determine a block format for the next block to be transmitted to the subscriber station.

Preferably, in each of the above aspects of the invention, the reception-quality measured is signal to interference ratio.

According to a seventh aspect of the present invention, a data signal embodied in a carrier wave is provided. The signal comprises a set of transmit-control bits. Each bit is carried in a discrete slot of a slotted frame of data transmitted on a dedicated channel from a subscriber station to a base station. The transmit-control bits together represent a quantized measurement of reception-quality measured at the subscriber station of a frame of data transmitted by the base station.

According to an eighth aspect of the present invention, a subscriber station is provided having a microprocessor, a modem, a radio and an antenna, and operable to receive data from a base station over a shared channel and transmit data to the base station over a dedicated channel. The subscriber station is configured to measure a reception-quality of each frame of data received over the shared channel from the base station, map the reception-quality measurement to a set of transmit-control bits using a quantization mapping, and transmit the set of transmit-control bits to the base station in a slotted frame of data, each transmit-control bit carried in a discrete slot.

According to an eighth aspect of the present invention, a subscriber station is provided having a microprocessor, a modem, a radio and an antenna, and operable to receive data from a base station over a shared channel and transmit data to the base station over a dedicated channel. The subscriber station configured to measure a reception-quality of each frame of data received over the shared channel from the base station and to periodically transmit an average of a portion of a series of such reception-quality measurements to the base station.

Preferably, each average transmitted to the base station is determined by accumulating a plurality of receptor-quality measurements, sting the accumulated measurements into a list by magnitude, separating the sorted measurements into groups by position in the list, and averaging the measurements in the group having the lowest reception-quality.

According to an ninth aspect of the present invention, a subscriber station is provided having a microprocessor, a modem, a radio and an antenna, and operable to receive data from a base station over a shared channel and transmit data to the base station over a dedicated channel. The subscriber station is configured to measure a reception-quality of each frame of data received over the shared channel from the base station and to both:

(a) periodically transit an average of a portion of a series of such reception-quality measurements to the base station; and

(b) map each reception-quality measurement to a set of transmit-control bits using a quantization mapping and transmit the set of transmit-control bits to the base station in a slotted frame of data, each transmit-control bit carried in a discrete slot.

According to a tenth aspect of the present invention, a base station is provided having a microprocessor, a modem, a radio and an antenna, and operable to transmit data to a plurality of subscriber stations over a shared channel and receive data from a subscriber station over a dedicated channel. The base station is configured to receive from the subscriber station both:

(a) a periodically transmitted average of a portion of a series of measurements of a reception-quality of each frame of data received over the shared channel by the subscriber station, and

(b) over the dedicated channel slotted frames of data, each frame carrying a set of transit-control bits corresponding to a reception-quality measurement of a different frame of data received over the shared channel by the subscriber station, the set of transmit-control bits determined using a quantization mapping, each transmit-control bit carried in a discrete slot.

Preferably, each average transmitted to the base station is determined by accumulating a plurality of reception-quality measurements, sorting the accumulated measurements into a list by magnitude, separating the sorted measurements into groups by position in the list and averaging the measurements in the group having the lowest reception-quality.

According to an eleventh aspect of the present invention, a system for transmitting data over a shared channel is provided. The system includes a base station and at least one subscriber station as described above.

### BRIEF DESCRIPTION OF THE DRAWINGS

Embodiments of the present invention will now be described, by way of example only, with reference to the attached Figures, wherein:

FIGS. 1A-1D depict various forms of fading of a communication channel;

FIG. 2 is a schematic representation of a wireless network in accordance with an embodiment of the invention;

FIG. 3 is a representation of a communications link as shown in FIG. 1, comprised of multiple channels;

FIG. 4 is a schematic representation of the base station shown in FIG. 1;

FIG. 5 is a schematic representation of one of the subscriber stations shown in FIG. 1; and

FIGS. 6 and 7 are flowcharts illustrating an embodiment of the invention

### DETAILED DESCRIPTION OF THE INVENTION

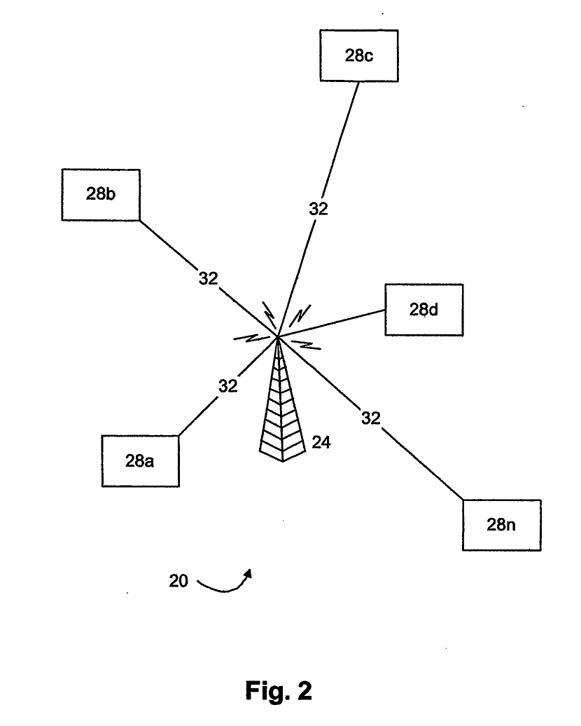

Referring to FIG. 2, a wireless network for transmitting data is indicated generally at 20. Network 20 includes a radio base station 24 and a plurality of subscriber stations 28a, 28b, . . . 28n. In a presently preferred embodiment, radio base station 24 is connected to at least one data telecommunications network (not shown), such as a land line-based switched data network, a packet network, etc., by an appropriate gateway and one or more backhauls (not shown), such as a T1, T3, E1, E3, OC3 or other suitable land line link or a satellite or other radio or microwave channel link or any other link suitable for operation as a backhaul as will occur to those of skill in the art.

Base station 24 communicates with subscriber stations 28, which can be fixed, nomadic or mobile devices. The number ‘n’ of subscriber stations serviced by a base station 24 can vary depending upon the amount of radio bandwidth available and/or the configuration and requirements of the subscriber stations 28.

A communications link 32 is established between base station 24 and each subscriber station 28 via radio. Communications link 32 can be implemented using a variety of multiple access techniques, including TDMA, FDMA, CDMA or hybrid systems such as GSM, etc. In a present embodiment, data transmitted over communications link 32 is transmitted using CDMA as a multiple access technology and the data is in the form of blocks, transmitted within slotted time frames, the details of which win be discussed in greater detail below.

Reception-quality can be measured in different manners according to the multiple access technique employed to transmit the signal For example, in TDMA or FDMA systems, the received signal strength is the determination most often used. In CDMA systems, the ratio of received bit power to received interference power (often expressed as Eₛ/Nₒ, where Eₛ is energy per symbol, and Nₒ is the received interference energy) is a relevant determination.

The reception-quality of communications link 32 at each subscriber station 28 can vary depending on a variety of factors, including multipath interference (from the presence of nearby buildings, etc.), radio noise sources (including transmissions by other users or radio noise sources), geographical features, the distance of the subscriber station 28 from base station 24, the quality of the receiver in the subscriber station 28, etc. as is well understood by those of skill in the art. With distance, typically a signal attenuates as

$$\frac{1}{{r}^{N}} ,$$

where r is the distance between the subscriber station 28 and base station 24, and N>1. In IS-95 CDMA systems, for example, N typically is in the range of 3<N<5.

Communications link 32 operates in both an uplink (from a subscriber station 28 to base station 24) and a downlink direction (from base station 24 to subscriber stations 28). The method of providing both uplink and downlink directions is not particularly limited, and in the present embodiment communications link 32 operates by frequency division duplexing (FDD). However, other methods of providing both uplink and downlink directions, such as time division duplexing (TDD) and hybrid schemes are within the scope of the invention.

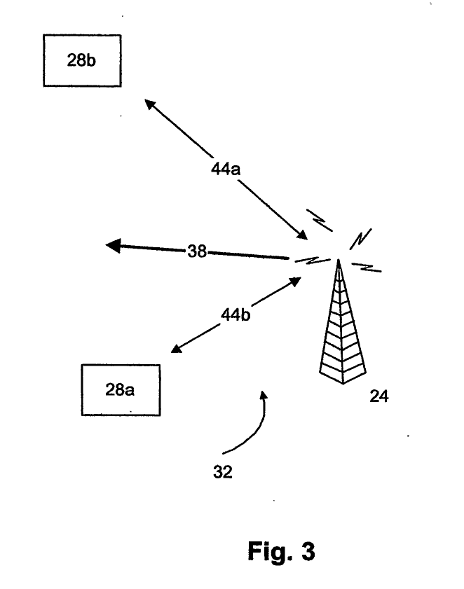

Referring now to FIG. 3, in the current embodiment, communications link 32 is comprised of a plurality of channels, which in the present CDMA implementation is achieved with orthogonal coding of communications link 32. In the downlink direction, base station 24 uses a shared channel referred to as the broadcast data channel (BDCH) 38 to carry variable-rate and bursty traffic consisting primarily of signaling and Internet traffic. BDCH 38 makes use of adaptive FEC and modulation to maximize downlink capacity and contains multiple packets or, more commonly, blocks containing segments of packets of data for various subscriber stations 28, all time-multiplexed together into a single frame. In the present embodiment, BDCH 38 can be configured with spreading factor 4, wherein eight blocks of data can be sent within a ten-millisecond frame, spreading factor 8 wherein four blocks of data can be sent within a frame or spreading factor 16 wherein two blocks of data can be sent within a frame. Normally the spreading factor of a BDCH 38 is predetermined by a network operator and is fixed for every subscriber station 28 that is being serviced by a particular BDCH 38.

A separate bi-directional dedicated data channel (DDCH) 44 is also set up between each subscriber station 28 with an active communications link 32 and the base station 24. Subscriber stations 28 measure their received reception-quality and report this information back to base station 24 on a regular basis over their uplink DDCH 44. Subscriber stations 28 with high reception-qualities allow the base station 24 to use less channel coding and/or higher order modulation to transmit blocks of data on BDCH 38 than subscriber stations 28 with lower reception-qualities and thus, each block of data transmitted on BDCH 38 can use a different block type (i.e., different packaging of FEC type, FEC rate, modulation, etc.).

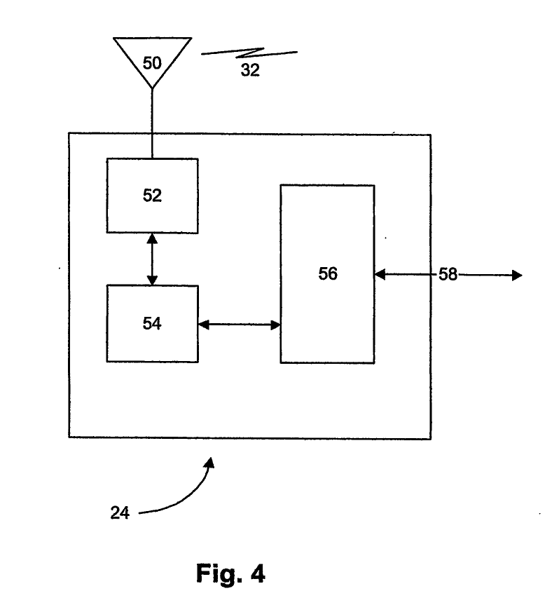

FIG. 4 shows an example of a base station 24 in greater detail. For the sake of clarity, base station 24 shows an example of a single sector base station. However, multi-sector base stations 24 are also within the scope of the invention. Base station 24 comprises an antenna 50, or antennas, for receiving and transmitting radio-communications over communications link 32. In turn, antenna 50 is connected to a radio 52 and a modem 54. Modem 50 is connected to a microprocessor-router assembly 56 such as an Intel Corporation Pentium processor based system using a conventional operating system such as Linux. Microprocessor-router assembly 56 is responsible for radio resource management. It will be understood that assembly 56 can include multiple microprocessors as desired and/or that the router can be provided as a separate unit, if desired. The router within microprocessor-router assembly 56 is connected to a backhaul 58 in any suitable manner, which in turn connects base station 24 to a data network (not shown).

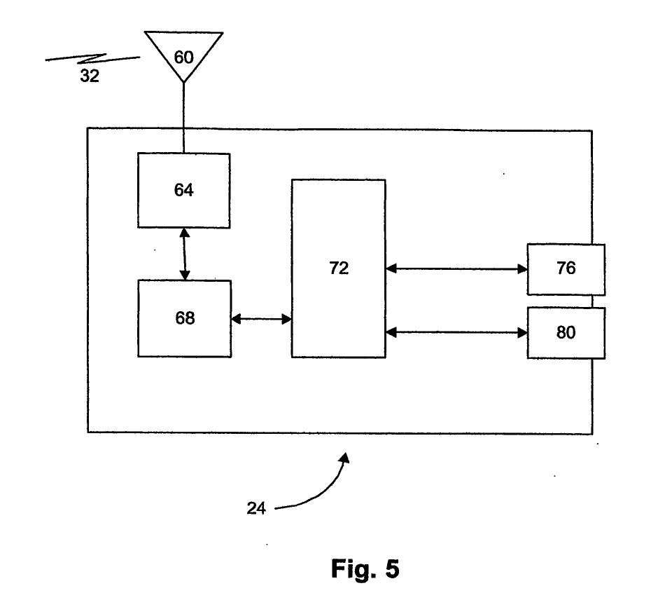

Referring now to FIG. 5, an example of a subscriber station 28 is shown in greater detail Subscriber station 28 comprises an antenna 60, or antennas, for receiving and transmitting radio-communications over communications link 32. In turn, antenna 60 is connected to a radio 64 and a modem 68, which in turn is connected to a microprocessor-assembly 72.

Microprocessor-assembly 72 can include, for example, a StrongARM processor manufactured by Intel Corporation which performs a variety of functions, including implementing A/D-D/A conversion, filters, encoders, decoders, data compressors, de-compressors and/or packet disassembly.

As shown in FIG. 5, microprocessor-assembly 72 interconnects modem 68 and a data port 76, for connecting subscriber station 28 to a data client device (not shown), such as a personal computer, personal digital assistant or the like that is operable to use data received over communications link 32. Accordingly, microprocessor-assembly 72 is operable to process data between data port 76 and modem 68. Microprocessor-assembly 72 is also interconnected to at least one telephony port 80, for connecting subscriber station 28 to a telephony device (not shown) such as a telephone. In some cases, particularly in the case of a mobile subscriber station 28, the data client device can be integrated into the subscriber station 28.

In the current embodiment of the invention, each subscriber station 28 in a network 20 with an active communications link 32 makes a measurement of reception-quality for each 10 millisecond BDCH frame by measuring the power and magnitude of the header symbols that preface each block of data sent over the BDCH 38 in that frame. These header symbols are packaged to be readable by all subscriber stations 28 in the network 20, regardless of the packaging used for the blocks of data. Hence all subscriber stations 28 in the network 20 are able to obtain a measurement of reception-quality for each BDCH frame.

In the current embodiment of the invention, two types of subscriber stations 28 may be used The difference between them lies in the reception-quality data that the subscriber station 28 is able to provide to the base station 24 over the subscriber station's uplink DDCH 44.

A first type of subscriber station 28, referred to as a Type I subscriber station 28, provides the base station 24 with a periodic histogram-based average reception-quality determined by taking an average of the lowest 10% of last 100 measurements (one second) of reception-quality and sending that average to the base station 24 as data over its uplink DDCH 44. A second type of subscriber station 28, referred to as a Type II subscriber station 28, also provides each reception-quality measurement to the base station 24. Hence, for Type II subscriber stations 28, the base station 24 has available both an up-to-date measurement of reception-quality as well as an average over the last second of the worst measurements of reception-quality.

Each uplink DDCH 44 carries data in 10 millisecond frames, each divided into 15 slots. In each slot there is one transmit-control bit, for a total of 15 transmit-control bits per frame. For a Type I subscriber station 28, all 15 transmit-control bits are used to control the power used by the base station 24 to transmit the downlink DDCH 44 channel to that subscriber station 28. For a Type II subscriber station 28, the number of transmit-control bits used to control transmit power is reduced to five. Five of the remaining transmit-control bits are used to send quantized reception-quality measurements. Four bits of those five bits are used as data bits and the remaining bit is used as a parity bit generated by XORing the four data bits together. The remaining five transmit-control bits are presently reserved for future uses. The distribution of transmit-control bits in each frame sent by a Type II subscriber station 28 is as follows:
X/T/M0/M1/T/M2/M3/T/P4/X/T/X/X/T/X
   where slashes delimit slots, T represents a transit power control bit, M0-M3 represent quantized data bits, P4 represents the parity bit, and X represents a reserved bit. Other distributions of transmit-control bits may be used, but in the present implementation, transmit power control bits are generated once every three slots and the quantized data bits and parity bit should preferably be transmitted relatively close to the beginning of the frame to provide time for the BDCH block format for the next frame to be determined and the next frame assembled before the next frame needs to be ready to transmit. By comparison, the distribution of transmit-control bits in each frame sent by a Type I subscriber station 28 is all Ts separated by slashes.

The base station 24 to determine BDCH block format for blocks transmitted to Type I subscriber stations 28 uses a form of adaptation referred to here as “slow adaptation”. A different form of adaptation referred to here as “fast adaptation” is presently used to determine BDCH block format for blocks transmitted to Type II subscriber stations 28, although under some circumstances the BDCH block format for blocks transmitted to Type II subscriber stations 28 may be determined in the same manner as for blocks transmitted to Type I subscriber stations 28.

If the base station 24 is using slow adaptation to determine the BDCH block format for blocks transmitted to a Type I subscriber station, then the reception-qty used to determine the block format for the next BDCH block to be transmitted by a base station 24 to that subscriber station 28 is updated periodically based upon the histogram-based average reception-quality reported by that subscriber station 28. The manner in which the histogram-based average reception-quality is determined is described above.

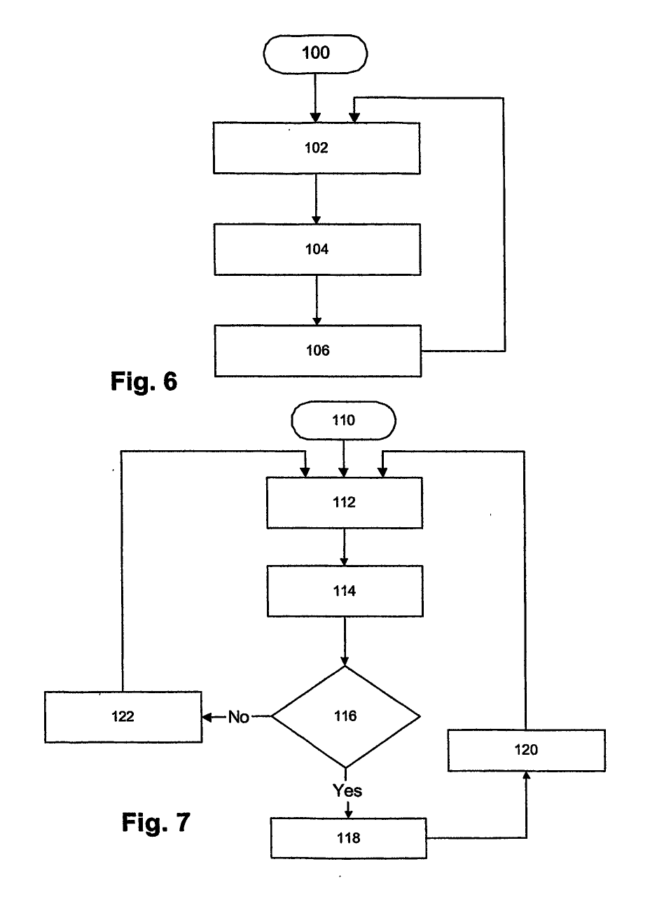

A flowchart showing an example of the slow adaptation process is shown in FIG. 6. The process, which starts at block 100, may be run continuously as shown in FIG. 6, or may be run periodically or upon the occurrence of some event. In the present embodiment of the invention, the process runs continuously and concurrently with other processes running in the subscriber station 28 and the base station 24. From start block 100, the process proceeds to block 102 in which a series of reception quality measurements are taken. When a predetermined number of measurements (presently 100) have been taken, the process proceeds to block 104 in which an average of a group (presently the lowest 10%) of reception-quality measurements just taken is determined. The process then proceeds to block 106 in which either a block format is determined in the subscriber station 28 and communicated over a DDCH 44 to the base station 24 or the average just determined is communicated over a DDCH 44 to the base station 24 and the base station determines a new block format. Presently, the average is communicated to the base station. In either case, the block format so determined is used for all blocks sent by the base station 24 to the subscriber station 28 over the BDCH channel 38 until a different block format is determined as a result of a further series of measurements. The process then returns to block 102 in which another series of reception-quality measurements are taken.

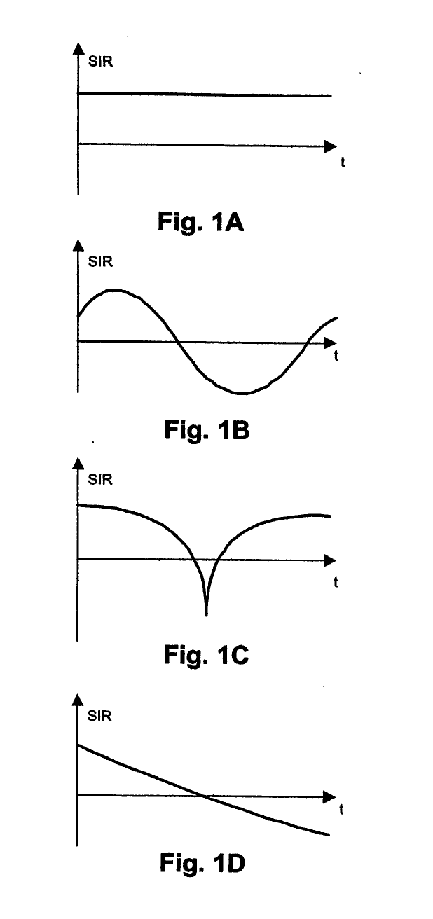

Because slow adaptation effectively uses an (almost) worst case reception-quality from the past behavior of the channel 38 to predict a floor for the reception-quality for the future behavior of the channel, if the prediction is accurate, then the block format will be determined from a reception-quality lower than the actual reception-quality experienced by the subscriber station 28 in receiving the block through most of the next second, thereby holding the error rate to a relatively low level. In the present embodiment, if the average of the lowest 10% of the last 100 reception-quality measurements varies with time, then slow adaptation will be superior to using a fixed block format. If that average does not vary, then slow adaptation would not be necessary. Since in some circumstances the period over which reception-quality measurements are taken might not long enough to provide a good prediction of the reception-quality for the next period, a fide margin is necessary. For example, suppose that in FIG. 1B the period over which reception-quality measurements are taken turned out to be less than the period of variation of the SIR. The block format could then be chosen based upon either too high or too low a reception-quality, resulting in either an increased error rate or a lower than necessary data rate. To ensure that the error rate does not increase, a fade margin may be used that is based upon a prediction of the range of variation of the reception-quality over the measurement period.

Assuming that the sampling period is long enough to have sampled at least one previous fast, deep fade, slow adaptation will handle fast, deep fades such as that shown in FIG. 1C with a lower error rate than fast adaptation because it does not attempt to track the instantaneous reception-quality. The downside is that slow adaptation will result in a lower data rate than fast adaptation in other fading situations, such as those shown in FIGS. 1B and 1D because it is using a worst case reception-quality and possibly a large fade margin. However, it likely to provide a better data rate than using a fixed block format. Overall, slow adaptation appears to be better than fast adaptation or a fixed block format in environments in which fast deep fades occur.

If the base station 24 is using fast adaptation to determine the BDCH block format for blocks transmitted to a Type II subscriber station, then the reception-quality used to determine the block format for the next BDCH block to be transmitted by a base station 24 to that subscriber station 28 is updated periodically based upon the reception-quality last reported by that subscriber station 28. More specifically, when a Type II subscriber station 28 becomes connected to a base station 24 it receives a quantization mapping from the base station 24. For each BDCH frame that the Type II subscriber station 28 then receives, the Type II subscriber station 28 maps the reception-quality measurement for that frame to a set of transmit-control bits M0-M3 and P4 using the quantization mapping and transmits those transmit-control bits in the next uplink DDCH 44 frame sent to the base station 24. The base station 24 uses the transmit-control bits M0-M3 and P4 received from subscriber station 28 and the same quantization mapping to determine the quantized reception-quality in the quantization mapping that was just above the reception-quality measurement obtained from the subscriber station 28. An offset (in effect a fade margin) may be added or subtracted from the quantized reception-quality depending upon the type of data traffic. The quantized reception-quality is used to determine the block format for the next BDCH block to be transmitted to the subscriber station 28.

It is thought that fast adaptation at present rate of 100 Hz (once for each 10 ms frame) win be fast enough for pedestrian-speed fading and nomadic use and that the base station 24 win only need to use slow adaptation for Type I subscriber stations 28. However, because Type II subscriber stations 28 provide the data necessary for slow adaptation as well as fast adaptation, it may be that in some circumstances the base station 24 may switch to determining the block format for the next BDCH block to be transmitted to a Type II subscriber station 28 using slow adaptation.

For example, in the present embodiment, if there is a parity error in the set of transmit-control bits M0-M3, then the base station 24 ignores that set of transmit-control bits M0-M3 and bases the block format for the next BDCH block upon the last set of transmit-control bits M0-M3 for which there was no panty error. Alternatively, the base station 24 could temporarily switch to slow adaptation until the parity errors stop.

Another situation in which the base station 24 might temporarily switch to slow adaptation for a Type II subscriber station 28 is when there are fades that are too fast to be tracked at 100 Hz. Herein “track” means to accurately determine, from a measurements of the reception-quality and its instantaneous rate of change, a block format for the each block that is transmitted so that some predetermined limit on the error rate is met. If the rate of change of the reception-quality is too high for the system 20 to track, then slow adaptation may be used until the rate of change of the reception-quality drops enough for the system 20 to track, at which point the system 20 switches back to fast adaptation.

In general, failure to track channel fading may result from the finite time needed to:

(1) estimate the instantaneous rate of change of the reception-quality,

(2) either
(a) communicate that estimate and a measurement of the present reception-quality to the base station 24 and, at the base station 24, determine a block format and package the data into the next block using that block format, or
(b) at the subscriber station 28, determine a block format using that estimate and measurement, communicate an indication of the determined block format to the base station 24, and at the base station 24 package the data into next block using that block format; and

(3) transport the next block from the base station 24 to the subscriber station 28.

Hence, whether at any particular time the channel fading can be accurately estimated depends upon a number of factors, including the actual rate of change of the reception-quality (or some other indicator of the rate of change of reception-quality), how rapidly measurements of the reception-quality can be obtained, the distance between the subscriber station 28 and the base station 24, and the processing resources available.

One way in which the rate of change of the reception-quality may be estimated is by collecting a time sequence of reception-quality measurements and computing their magnitude FFT. The centroid of the magnitude frequency response may then be calculated and used as an indication of the rate of change of the reception-quality. Alternatively, a measure may be used that depends upon how well fast adaptation is working, such as the frequency of re-transmission requests made by the subscriber station 28 to the base station 24. Other ways to estimate the rate of change of the reception-quality will occur to those skilled in the art.

A flowchart showing one embodiment of a process combining the fast and slow adaptation processes is shown in FIG. 7. The process starts at block 110 and runs continuously and concurrently with other processes running in the subscriber station 28 and the base station 24. From start block 110, the process proceeds to block 112 in which a series of reception-quality measurements are taken. When a predetermined number of measurements have been tall the process proceeds to block 114 in which a measure of the rate of change of the reception-quality is determined. For example, the most recent or all of the series of reception-quality measurements just taken or the rate at which re-transmission requests have been made by the subscriber station 28 over some predetermined period may be used to determine a measure of the instantaneous rate of change of the reception-quality. Next, the measure of the instantaneous rate of change of the reception-quality is compared at block 116 to an empirically determined maximum rate of change of the reception-quality that the system 20 can track without exceeding some predetermine limit on the error rate. If the system 20 cannot track, then processing proceeds to block 118 in which an average of a group of reception-quality measurements most recently taken is determined. The process then proceeds to block 120 in which either a block format is determined in the subscriber station 28 and communicated over that subscriber station's uplink DDCH 44 to the base station 24 or the average just determined is communicated over that subscriber station's uplink DDCH 44 to the base station 24 and the base station determines a new block format. In either case, fast adaptation is stopped if has been being used and the block format so determined is used for all blocks sent by the base station 24 to the subscriber station 28 over the BDCH channel 38 until a different block format is determined as a result of a further series of measurements or the process switches to fast adaptation again. The process then returns to block 110 in which another series of reception-quality measurements are taken. If at block 116, the system 20 can track, then processing proceeds to block 122 in which fast adaptation is stared if it is not already being used. The process then returns to block 112 in which a new series of reception quality measurements are taken.

The process illustrated in FIG. 7 periodically makes an estimate of the instantaneous rate of change of the reception-quality with a frequency and phase such that the making of an estimate occurs immediately after the completion of a series of reception-quality measurements that will be used in slow adaptation method if it is determined from the estimate that the system 20 can no longer track. Alternatively, the system 20 may be configured to make estimates of the instantaneous rate of change of the reception-quality more or less frequently.

For example, depending upon the processing power of the microprocessor-assemblies 56, 72 in the base station 24 and the subscriber station 28, it may be necessary to decouple the rate at which the measure of the instantaneous rate of change of the reception-quality is determined from the calculation of averages for slow adaptation. For example, it may not be possible to apply an FFT to a sliding window of reception-quality measurements due to a lack of available processing power.

Those skilled in the art will understand that the process shown in FIG. 7 could be divided into three concurrent processes. The first process could determine block formats that could be used in the slow adaptation method. The second process could determine block formats that could be used in the fast adaptation method. The third process could periodically, with a frequency and phase that is not necessarily the same as the first process, determine a measure of the instantaneous rate of change of the reception-quality and compare that measure against the empirically determined maximum rate of change of the reception-quality that the system 20 can track. The third process could be aware of which of the first and second processes is presently being used to determine the block format of blocks of data that are being transmitted and, if the appropriate adaptation method is not presently being used, it could cause take action to cause the system 20 to switch to using block formats determined by the other of the first and second processes. A further alternative would be to run the third process only when some other metric such as the rate at which retransmission requests are being received exceeds some empirically determined limit.

In the present embodiment of the invention, the five unused transmit-control bits in each uplink DDCH 44 frame mentioned above could be used to transmit a measure of the rate of change of the reception-quality to the base station 24, which could then used to decide when to switch back and forth between fast and slow adaptation.

The above-described embodiments of the invention are intended to be examples of the present invention and those of skill in the art may effect alterations and modifications thereto, without departing from the scope of the invention, which is defined solely by the claims appended hereto.

1.-40. (canceled)

41. A method of determining block formats to be used to transmit blocks of data from a transmitter to a receiver over a channel subject to fading, the method comprising:
measuring a reception-quality of data received by the receiver over the channel from the transmitter;
monitoring a measure of the rate of change of the reception-quality of data received by the receiver over the channel from the transmitter; and
if the measure of the rate of change of the reception-quality indicates that measurements of the reception-quality are being obtained and provided to the transmitter fast enough so that each measurement of reception-quality is a reasonably accurate estimate of the reception-quality at which the receiver will receive the next block to be transmitted, then determining a format for the next block to be transmitted by the transmitter to the receiver using the most recent measurement of reception-quality provided to the transmitter, but otherwise, determining a format for the next block to be transmitted by the transmitter to the receiver using an average of a portion of the reception-quality measurements received by the receiver over the channel from the transmitter.

42. The method of claim 41, wherein the measure of the rate of change of the reception-quality of data transmitted over the channel from the transmitter to the receiver is determined periodically, but with a different period or phase than measurements of reception-quality of data transmitted over the channel from the transmitter to the receiver are made.

43. The method of claim 41, wherein the channel is a wireless channel, the receiver is a subscriber station, and the transmitter is a base station.

44. The method of claim 41, wherein the reception-quality measurements used to determine the average are sorted into portions by magnitude and one of the portions so determined is used to determine the average.

45. The method of claim 44, wherein the sorted portion used to determine the average is the portion having the lowest magnitudes.

46. The method of claim 41, wherein the measure of the rate of change of the reception-quality is determined from a sequence of reception-quality measurements.

47. The method of claim 46, wherein the measure of the rate of change of the reception-quality is determined by finding the frequency spectrum of the sequence of reception-quality measurements.

48. The method of claim 41, wherein the measure of the rate of change of the reception-quality is determined from the rate at which the receiver is requesting retransmissions over the channel from the transmitter.

49. The method of claim 41, wherein each reception-quality measurement is mapped to a set of transmit-control bits using a quantization mapping, each set of transmit-control bits is transmitted from the receiver to the transmitter in a slotted frame of data, and each transmit-control bit is carried in a discrete slot of the frame.

50. The method of claim 49, wherein there are five transmit-control bits in the set of transmit-control bits, four of which are quantized data bits and the fifth bit is a parity bit generated by XORing the four data bits together, and wherein the slotted frame has 15 slots.

51. The method of claim 50, wherein the five transmit-control bits in the set of transmit-control bits are distributed among the 15 slots of the frame in the following manner:
X/T/M0/M1/T/M2/M3/T/P4/X/T/X/X/T/X,
in which slashes delimit slots, T represents a transmit power control bit used to control the power used by the transmitter to transmit a dedicated channel to the receiver, M0-M3 represent the quantized data bits, P4 represents the parity bit, and X represents a reserved bit.

52. An apparatus operable to transmit blocks of data in frames to a plurality of subscriber stations over a shared channel subject to fading, comprising:
a base station configured to receive from at least one of the subscriber stations over a dedicated channel both:
(a) a measurement of reception-quality of each frame of data received over the shared channel by that subscriber station, and
(b) a periodically transmitted average of a portion of a series of measurements of the reception-quality of frames of data received over the shared channel by that subscriber station,
wherein the base station is configured to determine a measure of the rate of change of the measurements of reception-quality of the frames of data received over the shared channel by that subscriber station and, if the measure of the rate of change of the reception-quality indicates that measurements of the reception-quality are being obtained and provided to the base station fast enough so that each measurement of reception-quality is a reasonably accurate estimate of the reception-quality at which the subscriber station will receive the next block to be transmitted to it, then determining a format for the next block to be transmitted by the base station to that subscriber station using the most recent measurement of reception-quality received by the base station, but otherwise, determining a format for the next block to be transmitted by the base station to that subscriber station using the average received from that subscriber station.

53. The apparatus of claim 52, wherein the measure of the rate of change of the reception-quality of frames of data transmitted over the shared channel from the base station to the subscriber station is determined periodically, but with a different period or phase than measurements of reception-quality of frames of data transmitted over the shared channel from the base station to the subscriber station are made.

54. The apparatus of claim 52, wherein the reception-quality measurements used to determine the average are sorted into portions by magnitude and one of the portions so determined is used to determine the average.

55. The apparatus of claim 52, wherein the sorted portion used to determine the average is the portion having the lowest magnitudes.

56. The apparatus of claim 52, wherein the measure of the rate of change of the reception-quality is determined by finding the frequency spectrum of a sequence of reception-quality measurements.

57. The apparatus of claim 52, wherein the measure of the rate of change of the reception-quality is determined from the rate at which the subscriber station is requesting retransmissions over the shared channel from the base station.

58. The apparatus of claim 52, wherein each reception-quality measurement is mapped to a set of transmit-control bits using a quantization mapping, each set of transmit-control bits is transmitted from the subscriber station to the base station over a dedicated channel in a slotted frame of data, and each transmit-control bit is carried in a discrete slot of the frame.

59. The apparatus of claim 58, wherein there are five transmit-control bits in the set of transmit-control bits, four of which are quantized data bits and the fifth bit is a parity bit generated by XORing the four data bits together, and wherein the slotted frame has 15 slots.

60. The apparatus of claim 59, wherein the five transmit-control bits in the set of transmit-control bits are distributed among the 15 slots of the frame in the following manner:
X/T/M0/M1/T/M2/M3/T/P4/X/T/X/X/T/X,
in which slashes delimit slots, T represents a transmit power control bit used to control the power used by the base station to transmit a dedicated channel to the subscriber station, M0-M3 represent the quantized data bits, P4 represents the parity bit, and X represents a reserved bit.
